(19) United States
(12) Patent Application Publication
(10) Pub. No.: US 2015/0202720 A1
(43) Pub. Date: Jul. 23, 2015

(54) FIXING STRUCTURE FOR METAL UNIT AND PLASTIC UNIT

(71) Applicants: Lite-On Electronics (Guangzhou) Limited, Guangzhou (CN); Lite-On Technology Corporation, Taipei City (TW)

(72) Inventors: CHUNG-MING WANG, NEW TAIPEI CITY (TW); CHE-CHENG CHANG, TAIPEI CITY (TW); CHUN-CHING SHEN, NEW TAIPEI CITY (TW)

(73) Assignees: LITE-ON ELECTRONICS (GUANGZHOU) LIMITED, GUANGZHOU (CN); LITE-ON TECHNOLOGY CORPORATION, TAIPEI CITY (TW)

(21) Appl. No.: 14/252,345

(22) Filed: Apr. 14, 2014

(30) Foreign Application Priority Data
Jan. 22, 2014 (CN) 201420040889.1

(51) Int. Cl. B23K 31/02

(52) U.S. Cl. CPC B23K 31/02

(57) ABSTRACT

A fixing structure for a metal unit and a plastic unit includes a metal unit, a metal engagement portion, a plastic unit and a plastic engagement portion. The metal unit has a metal main body and a base body formed on one side of the metal main body. The metal engagement portion is a metal body fixed by welding to the base body of the metal unit. The plastic unit has a plastic main body. The plastic engagement portion is integrally formed as one piece on the plastic main body. The plastic unit is accommodated in the metal main body of the metal unit, and the metal engagement portion and the plastic engagement portion are mutually engaged. Aesthetics is increased and thermal cycle tests can be passed.

### BACKGROUND OF THE INVENTION

1. Field of the Invention

The present disclosure relates to a fixing structure; in particular, to a fixing structure for a metal unit and a plastic unit unaffected by changes in temperature.

2. Description of Related Art

Some electronic devices (e.g. computer, communication devices, consumer electronics) include metal units and plastic units. The metal units and the plastic units are formed separately and then joined by appropriate fixing structures. Fixing structure for a metal unit and a plastic unit on the current market generally belong to one of two types. The first type disposes the fixing structure inside a product. The fixing structure can include snapping units or screws arranged in a region shielded by another set of unit so as to not affect the appearance. This type of fixing structure is more stable, and can pass thermal cycle tests that simulate the changes in temperature endured by electronic products in containers during shipping. However, the fixing structure is disposed inside the product, so the metal unit needs to have a bent edge to allow the metal unit to extend from the visible region inward to form the fixing structure. The design of a bent edge produces rounded edges, and the gaps created by the rounded edges seriously affect the appearance.

The second type fixes the metal unit and the plastic unit by adhesives such as liquid glue, double-sided tape or hot melt glue to adhere the metal unit to the plastic unit. This type of structure does not require any particular structure other than grooves for preventing overflow of glue. However, this type of fixing structure requires a definite size of adhering surface to ensure the quality of adherence. If the adhering surface is insufficient, during thermal cycle tests, the difference between the thermal expansion coefficients of metal and plastic results in poor assembly quality.

Hence, the present inventor believes the above mentioned disadvantages can be overcome, and through devoted research combined with application of theory, finally proposes the present disclosure which has a reasonable design and effectively improves upon the above mentioned disadvantages.

### SUMMARY OF THE INVENTION

The object of the present disclosure is design a structure for electronic products to preserve the sharp edges produced by punching metals and the gaps formed by plastic units. Visually, the design has no gaps to raise the quality and value of the product, and is stable enough to solve the changes caused by thermal cycle tests.

In order to achieve the aforementioned objects, the present disclosure provides a fixing structure for a metal unit and a plastic unit including: a metal unit having a metal main body and a base body formed on one side of the metal main body; a metal engagement portion made of metal and fixed by welding onto the base body of the metal unit; a plastic unit having a plastic main body; and a plastic engagement portion integrally formed as one body on the plastic main body; wherein the plastic unit is accommodated inside the metal main body of the metal unit, and the metal engagement portion and the plastic engagement portion are mutually engaged.

The present disclosure has the following advantages. The present disclosure designs a fixing structure for a metal unit and plastic unit within a limited space, which overcomes the problem of poor assembly due to different thermal expansion coefficients of the metal unit and the plastic unit during thermal cycle tests, without altering the appearance of the original design nor significantly increasing production cost. The reliability of the product is increased, the customers are satisfied, and the competitiveness and the value of the product are raised.

In order to further the understanding regarding the present disclosure, the following embodiments are provided along with illustrations to facilitate the disclosure of the present disclosure.

### BRIEF DESCRIPTION OF THE DRAWINGS

FIG. 1 shows an exploded view of a fixing structure according to a first embodiment of the present disclosure;

FIG. 2 shows a perspective view of a metal engagement portion according to a first embodiment of the present disclosure;

FIG. 3 shows a perspective view of a metal unit and a metal engagement portion according to a first embodiment of the present disclosure;

FIG. 4 shows a perspective view of a plastic unit and a plastic engagement portion according to a first embodiment of the present disclosure;

FIG. 5 shows an assembly view of a fixing structure according to a first embodiment of the present disclosure;

FIG. 6 shows a cross-sectional view of a fixing structure according to a first embodiment of the present disclosure;

FIG. 7 shows a perspective view of a metal unit and a metal engagement portion according to a second embodiment of the present disclosure; and

FIG. 8 shows a perspective view of a plastic unit and a plastic engagement portion according to a second embodiment of the present disclosure.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

### First Embodiment

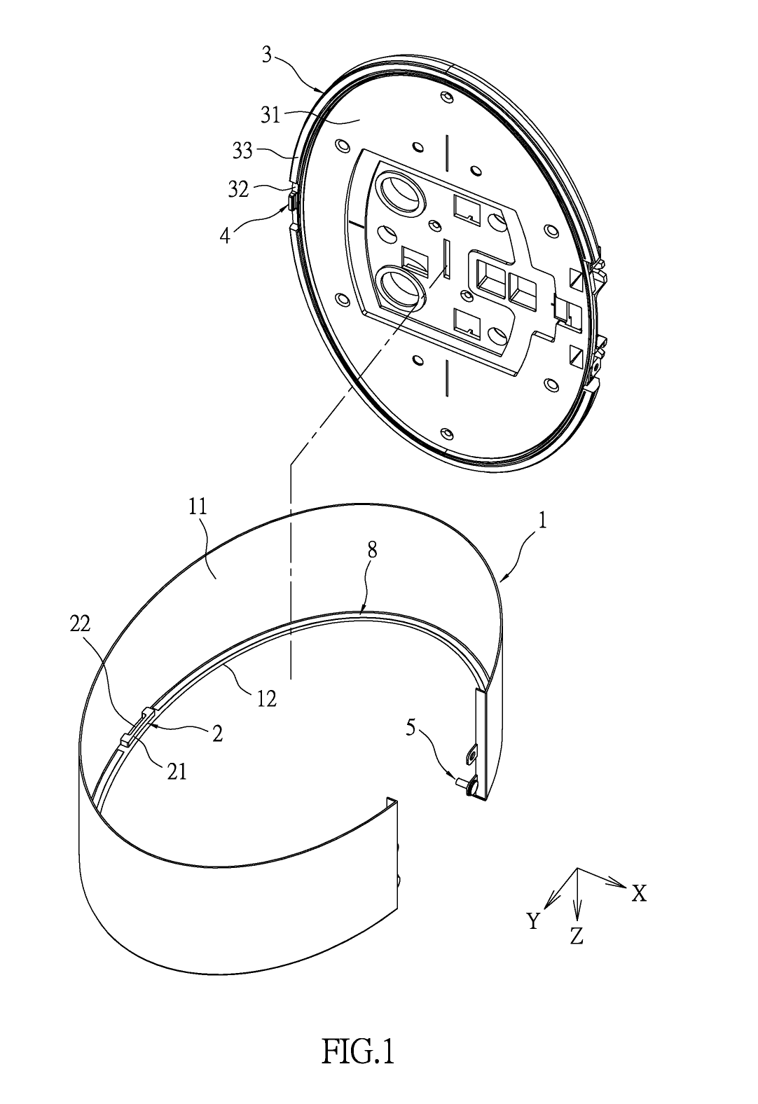

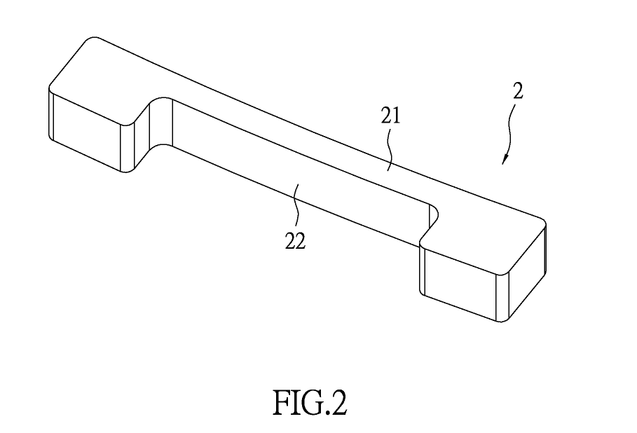

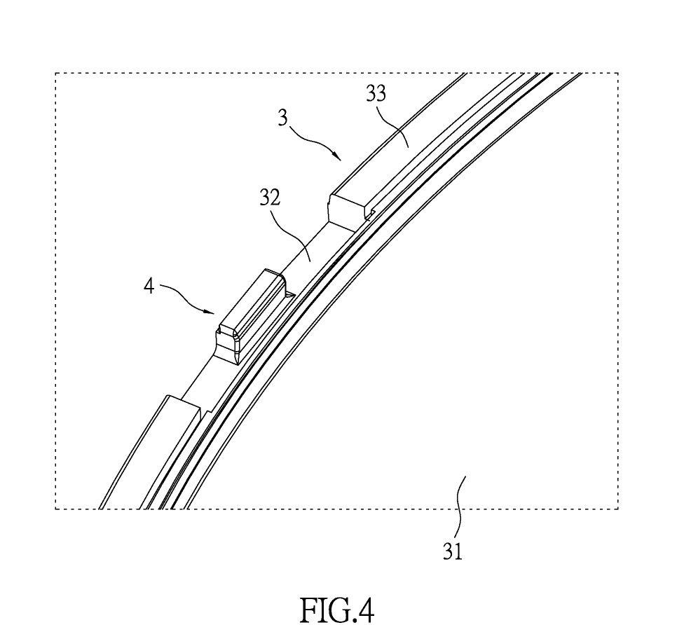

Referring to FIG. 1 to FIG. 4, the present disclosure provides a fixing structure for a metal unit and a plastic unit. The fixing structure can be applied to smart phones, tablet PCs, navigation systems, portable game systems, electronic dictionaries, audio and video broadcast devices, MP3s and other electronic devices. The present embodiment discloses a sound box product as an example. The application of the present disclosure is not limited thereto. The fixing structure includes a metal unit 1, at least one metal engagement portion 2, a plastic unit 3 and at least one plastic engagement portion 4.

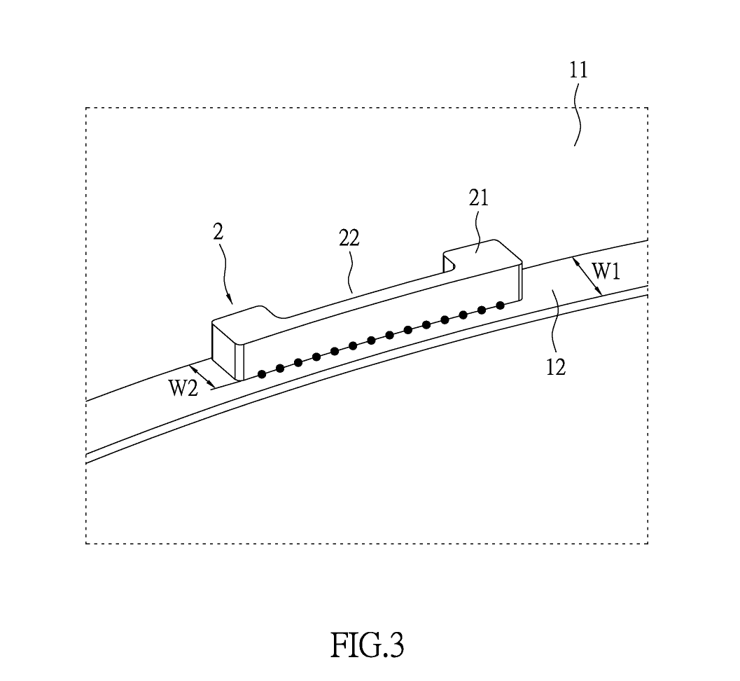

The metal unit 1 is made of metal. The shape and structure of the metal unit 1 is not limited and can be modified according to the type of product to which the metal unit 1 is applied. The metal unit 1 disclosed by the present embodiment is elliptical. Obviously, the metal unit 1 can also be circular, rectangular, polygonal or otherwise shaped. The metal unit 1 has a metal main body 11. A base body 12 is formed at one side of the metal main body 11. The base body 12 is arranged at the side of the metal main body 11 more adjacent to the plastic unit 3. The base body 12 protrudes from the inner part of the metal main body 11. The width W1 of the base body is not limited. Preferably, the width W1 of the base body is greater than the width W2 of the metal engagement portion (as shown in FIG. 3), such that the metal engagement portion 2 does not overhang the base 12. Preferably, the base body 12 is perpendicular to the metal main body 11 but is not limited thereto. The perpendicular arrangement between the base body 12 and the metal main body 11 facilitates the carrying of the metal engagement portion 2.

The metal engagement portion 2 is made of metal. Namely, the metal engagement portion 2 can be a metal body formed by punching. The quantity of the metal engagement portions 2 is not limited, and can be one, two or more. The present embodiment discloses an arrangement of one metal engagement portion 2. The shape and the structure of the metal engagement portion 2 are not limited, and can be modified according to needs. The metal engagement portion 2 can be an engagement slot or an engagement body. In the present embodiment the metal engagement portion 2 is an engagement slot. Namely the metal engagement portion 2 can have a base body 21 formed with a retaining slot 22. The retaining slot 22 can be a through hole, recessed slot, etc. In the present embodiment the base body 21 and the retaining slot 22 are rectangular but not limited thereto, and can be modified according to needs to be for example square-shaped, circular, polygonal-shaped, etc.

The metal engagement portion 2 is welded onto the base body 12 of the metal unit 1. For example, the metal engagement portion 2 can be welded to the base body 12 of the metal unit 1 by laser spot welding such that the base body 12 and the metal engagement portion 2 integrally form a retaining-slot structure. The position of fixture of the metal engagement portion 2 on the base body 12 of the metal unit 1 is not limited and can be modified according to need. In the present embodiment the metal engagement portion 2 is fixed at the middle of the base body 12 of the metal unit 1 to evenly distribute bearing force and effectively preventing horizontal displacement between the metal unit 1 and the plastic unit 3.

The plastic unit 3 is made of plastic. The shape and the structure of the plastic unit 3 are not limited and can be modified according to the type of product. The plastic unit 3 disclosed by the present embodiment corresponds to the metal unit 1 and is also elliptical. Obviously, the plastic unit 2 can also be circular, rectangular, polygonal or otherwise shaped. The plastic unit 3 has a plastic main body 31. The external wall of the plastic main body 31 is aligned to the interior wall of the metal main body 11, such that the plastic unit 3 is able to be accommodated inside the metal main body 11 of the metal unit 1 in an up and down direction.

The plastic engagement portion 4 is integrally formed as one body on the plastic main body 31. The quantity of the plastic engagement portions 4 is not limited, and can be one, two or more. The plastic engagement portion 4 disclosed by the present embodiment is aligned to the metal engagement portion 2. The shape and the structure of the plastic engagement portion 4 are not limited, and can be modified according to needs. The plastic engagement portion 4 can be an engagement body or an engagement slot. In the present embodiment the metal engagement portion 2 is an engagement body. Specifically, an edge of the plastic main body 31 is formed with a recess 32, and the plastic engagement portion 4 is a protruding rib, block or column disposed in the recess 32 to act as a retaining point. In the present embodiment the base body 21 and the retaining slot 22 are rectangular but not limited thereto, and can be modified according to needs to be for example square-shaped, circular, polygonal-shaped, etc. The edge of the plastic main body 31 can be formed with an adhering surface 33 corresponding to the base body 12. The adhering surface 33 can contact and be fixed to the base body 12.

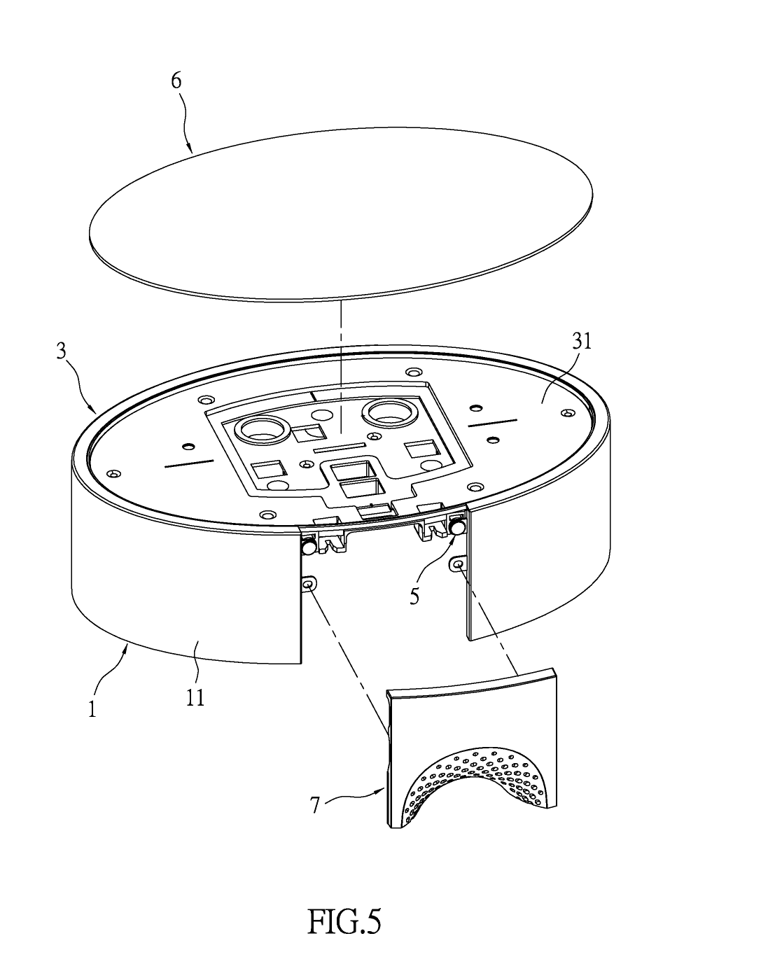

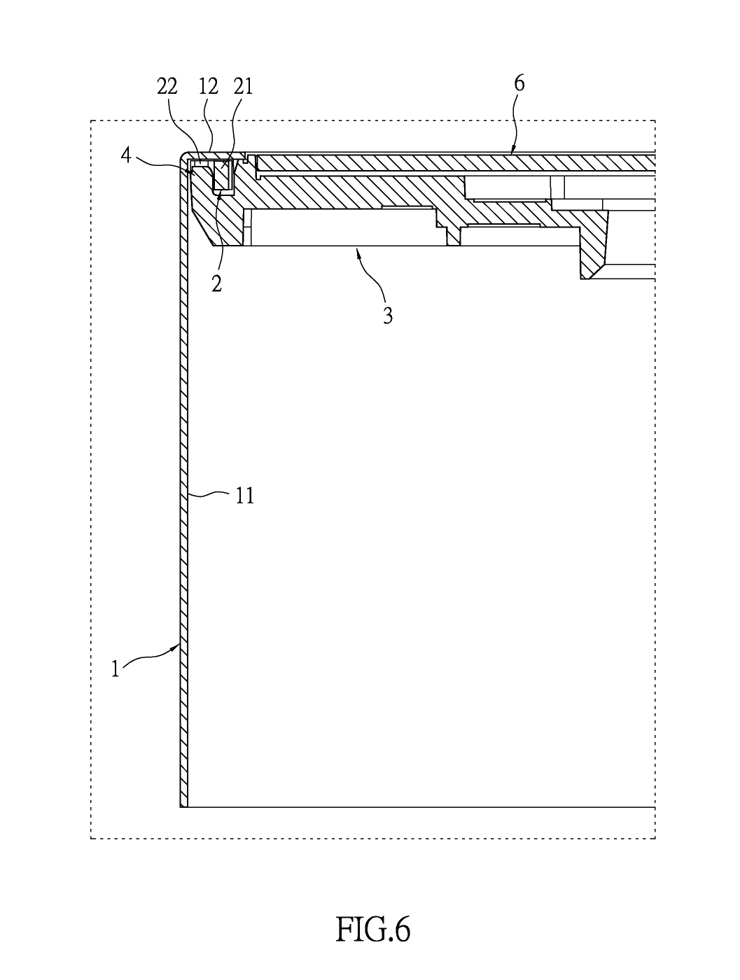

As shown in FIG. 1, FIG. 5 and FIG. 6, when the metal unit 1 and the plastic unit 3 of the present disclosure are assembled, the plastic unit 3 is accommodated in the metal main body 11 of the metal unit 1 from the top downward (in the direction of the z-axis as shown in FIG. 1), and the plastic engagement portion 4 and the metal engagement portion 2 are mutually engaged. Specifically, the base body 21 is accommodated in the recess 32, and the plastic engagement portion 4 is inserted into the retaining slot 22, to retain and fix the metal unit 1 to the plastic unit 3 and prevent horizontal displacement (in the directions of the x-axis and the y-axis as shown in FIG. 1) between the metal unit 1 and the plastic unit 3. Additionally, the adhering surface 33 of the edge of the plastic unit 3 and the base body 12 of the metal unit 1 can fixedly contact each other such that the metal unit 1 and the plastic unit 3 can be retained more securely.

Moreover, the metal unit 1 and the plastic unit 3 can be fixed by applying glue body 8 such as liquid glue, double-sided tape or hot melt glue therebetween. Additionally, two ends of the metal unit 1 and the plastic unit 3 can be fixed by screws 5 or other such methods of locking, such that the metal unit 1 and the plastic unit 3 are more securely integrated. The external side of the plastic unit 3 can be further attached with a decorative board 6, thereby increasing the aesthetics. A connection board can be locked between two ends of the metal unit 1 such that the metal unit 1 and the connection board 7 can form a complete annular body.

### Second Embodiment

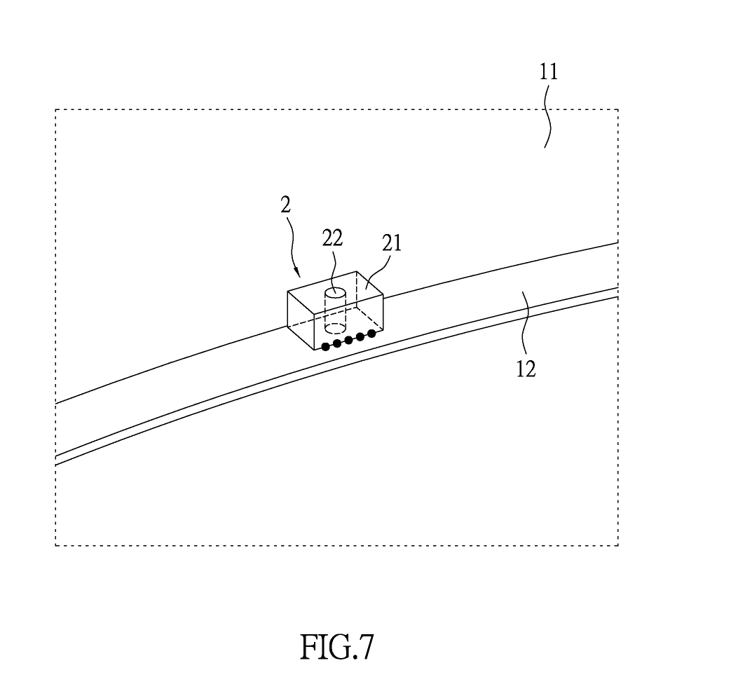

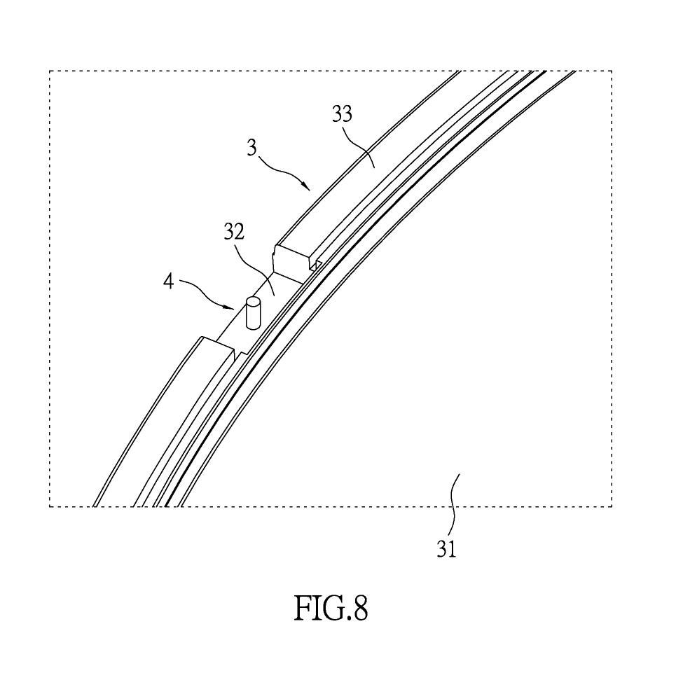

Referring to FIG. 7 and FIG. 8, the present embodiment discloses an arrangement of one metal engagement portion 2. The metal engagement portion 2 is an engagement slot. The base body 21 of the metal engagement portion 2 is formed with a retaining slot 22. The retaining slot 22 passes through the base body 21 from the top to the bottom. In the present embodiment the base body 21 is rectangular, and the retaining slot 22 is circular. The metal engagement portion 2 is welded onto the base body 12 of the metal unit 1. The plastic engagement portion 4 disclosed by the present embodiment is aligned to the metal engagement portion 2. The plastic engagement portion 4 is integrally formed as one body on the plastic main body 31. The plastic engagement portion 4 is an engagement body. The plastic engagement portion 4 is a protruding column disposed in the recess 32 to act as a retaining point. In the present embodiment the recess 32 is rectangular, and the plastic engagement portion 4 is circular. The metal engagement portion 2 and the plastic engagement portion 4 are mutually engaged to retain and fix the metal unit 1 to the plastic unit 3.

The present disclosure has the following advantages. The present disclosure has a preferable appearance. The fixing structure of the present disclosure avoids excessive gaps due to rounded corners produced by folding metal in designs of fixing structures for a metal unit and a plastic unit. The present disclosure preserves the sharp edges produced by punching metals and the (limited) gaps formed by plastic units. Visually, the design has no gaps to raise the quality and value of the product.

The present disclosure obtains preferable test results. The fixing structure of the present disclosure is a mechanical engagement design, and can be applied inside products to replace fixing by glue, preventing poor quality of assembly due to difference in thermal expansions coefficients of the metal unit and the plastic unit.

The present disclosure can be applied in a limited space. The fixing structure of the present disclosure can occupy space smaller than 3 millimeters by 15 millimeters. The dimensions of the fixing structure can be reduced according to the dimensions of the products, so that the fixing structure can be applied in products having limited space therein.

The production cost is reduced. The present disclosure fixes the metal engagement portion onto the metal unit by welding, and the plastic engagement portion is designed on the plastic unit, achieving the desired effects. The manufacturing process is suitable for mass production.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A fixing structure for a metal unit and a plastic unit, comprising:
a metal unit having a metal main body and a base body formed on one side of the metal main body;
a metal engagement portion fixed by welding to the base body of the metal unit;
a plastic unit having a plastic main body; and
a plastic engagement portion integrally formed on the plastic main body;
wherein the plastic unit is accommodated in the metal main body of the metal unit, and the metal engagement portion and the plastic engagement portion are mutually engaged.

2. The fixing structure for a metal unit and a plastic unit according to claim 1, wherein the metal engagement portion is an engagement slot, and the plastic engagement portion is an engagement body.

3. The fixing structure for a metal unit and a plastic unit according to claim 2, wherein the metal engagement portion has a base body formed with a retaining slot, the edge of the plastic main body is formed with a recess, the plastic engagement portion is arranged in the recess, the base body is accommodated in the recess, and the plastic engagement portion is inserted into the retaining slot.

4. The fixing structure for a metal unit and a plastic unit according to claim 1, wherein the metal engagement portion is an engagement body, and the plastic engagement portion is an engagement slot.

5. The fixing structure for a metal unit and a plastic unit according to claim 1, wherein the base body is arranged at a side of the metal unit adjacent to the plastic main body.

6. The fixing structure for a metal unit and a plastic unit according to claim 1, wherein the base body protrudes from an inner part of the metal main body, and the base body is perpendicular to the metal main body.

7. The fixing structure for a metal unit and a plastic unit according to claim 1, wherein the metal engagement portion is fixed at the middle of the base body of the metal unit.

8. The fixing structure for a metal unit and a plastic unit according to claim 1, wherein an edge of the plastic main body is formed with an adhering surface, and the adhering surface and the base body are fixedly in contact.

9. The fixing structure for a metal unit and a plastic unit according to claim 1, wherein the metal unit and the plastic unit are fixed to each other by glue.

10. The fixing structure for a metal unit and a plastic unit according to claim 1, wherein two ends of the metal unit are fixed by screws to the plastic unit.
